(19) United States
(12) Patent Application Publication
(10) Pub. No.: US 2008/0111764 A1
(43) Pub. Date: May 15, 2008

(54) Assistive device for people with communication difficulties

(75) Inventors: Thomas Francois HUGUES, Nimes (FR); Manuel Jose GONZALES, Nimes (FR)

Correspondence Address: Young & Thompson, Second Floor, 745 S. 23rd Street, Arlington, VA, 22202, US

(73) Assignee: SMARTIO SYSTEMS SARL, Nimes Cedex (FR)

(21) Appl. No.: 11/873,016

(22) Filed: Oct. 16, 2007

(30) Foreign Application Priority Data
Oct. 16, 2006 (FR) 06 10117

(51) Int. Cl. G09G 5/00

(52) U.S. Cl. 345/1.3

(57) ABSTRACT

The assistive device (100) comprises, in a portable housing adapted for use with a single hand:
at least two screens (105, 110) adapted to display images representative of messages,
a selector (115, 120) for selecting at least one message displayed on one of said screens
an emitter (125) for emitting sound messages and
a control means (190) for controlling the emission, by said emitter, of sound signals representative of each message selected with said selector.
   Preferably, at least one of said screens is a touch-screen. In particular embodiments, at least one touch-screen comprises both a capacitive sensor and a resistive sensor. In particular embodiments, at least one of said touch-screens comprises a capacitive sensor comprising a conductive loop positioned under said screen. Said loop is surrounded and/or superposed on a ground plane.

This invention concerns an assistive device for people with communication difficulties, for example people who are temporarily or permanently mute.

There are already devices assisting people with speech difficulties that comprise a keyboard on which phonemes or letters are represented and a speech synthesis circuit that vocally reproduces the phrases or words entered via keyboard. However, these devices are difficult to use because entering a message can be tiresome and entail the user using both hands or an aid. Moreover, these devices have poor autonomy due to their power consumption. Finally, these devices are heavy, bulky and cannot be personalized.

The aim of this invention is to remedy these inconveniences.

To this end, according to a first aspect, this invention is aimed at an assistive device that comprises, in a portable housing adapted for use with a single hand:
at least two screens adapted to display images representative of messages,
a selector for selecting at least one message displayed on one of said screens,
a emitter for emitting sound messages and
a control means adapted to control the emission, by said emitter, of sound signals representative of each message selected with said selector.

Thanks to these provisions, the user can utilize the two screens to select at least one message, the device then emitting a sound signal allowing third parties to understand each message selected by the user.

According to particular features, at least one of said screens is a touch-screen that comprises both a capacitive sensor and a resistive sensor.

The combination of the two technologies enables the device's service life to be increased.

According to particular features, at least one of said screens is a touch-screen that comprises a capacitive sensor positioned under said screen.

According to particular features, said capacitive sensor comprises a conductive loop placed under the screen.

According to particular features, said loop is surrounded and/or superposed on a ground plane.

According to particular features, at least one of said screens is equipped with a finger-guide adapted to guide the user's finger towards the surface of said screen.

According to particular features, the selector and the control means are adapted to control the scrolling of images on at least one of the screens.

According to particular features, the control means is adapted so that, during a scrolling operation, the same image is displayed successively on at least two screens.

According to particular features, the control means is adapted to perform a rotation operation on each image displayed on one of said screens.

According to particular features, the selector is placed between two of said screens.

According to particular features, the selector comprises a multidirectional switch, or “joystick”.

According to particular features, the selector is, in addition, adapted to control the scrolling of images and a sound power emitted by the emitter.

According to particular features, the selector and the control means are adapted to, firstly, scroll message categories and then, following the selection of a message category, to scroll messages for the category selected.

According to particular features, the selector and the control means are adapted to scroll message categories on one of said screens and, following the selection of a message category, to scroll messages for the category selected on the other one of said screens.

According to particular features, each image comprises a sub-title representing, in plain text, the message corresponding to the image.

According to particular features, the selector is adapted to select, to begin with, a first message, the first message being memorized by the control means, then a second message, the control means being adapted to actuate the emission of the first and second message consecutively, by the emitter.

According to particular features, the control means is adapted to memorize the first message when there is a long press on the selector.

According to particular features, at least one of the screens is an organic light-emitting diode display.

According to particular features, the device as described in brief above comprises an internal resonance box, one wall of which is formed by the emitter.

According to particular features, said resonance box comprises component fairings adapted to avoid, except at its end opposite to the emitter, the surfaces perpendicular to one axis of movement of the emitter.

According to particular features, the emitter is associated to bars with a triangular cross-section of which one angle is facing the emitter.

According to particular features, the device as described in brief above comprises an ambient noise sensor, the control means being adapted to control the sound power emitted by the emitter according to the ambient noise sensed by the ambient noise sensor.

According to particular features, the device as described in brief above comprises, in vertical longitudinal cross-section, a “W” shape.

According to particular features, the device as described in brief above comprises, in lateral cross-section passing through its bearing points in a stable position, a round shape.

According to particular features, the device as described in brief above comprises a center of gravity positioned below the centre of curvature of said round shape.

According to particular features, the device as described in brief above comprises one flat spot at least in the vicinity of its bearing points in a stable position.

According to particular features, the device as described in brief above comprises one connector adapted to connect it to at least two external contactors.

According to particular features, said connector is a standard connector for earphones.

According to particular features, the device as described in brief above comprises a connector adapted to connect it to a computer, the control means being adapted to receive and memorize images associated to messages by means of said connector.

Other advantages, aims and particular features of the present invention will become apparent from the description that will follow, made, as an example that is in no way limiting, with reference to the drawings included in an appendix, in which:

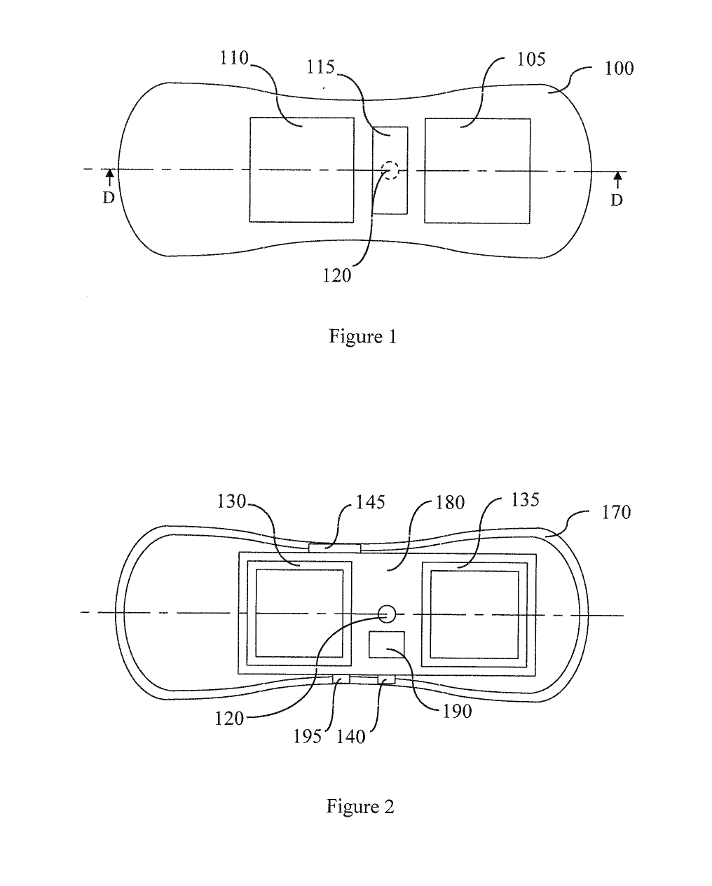

FIG. 1 represents, schematically, in a top view, a first particular embodiment of the device that is the subject of this invention;

FIG. 2 represents, schematically, in a first horizontal longitudinal profile view, the device shown in FIG. 1;

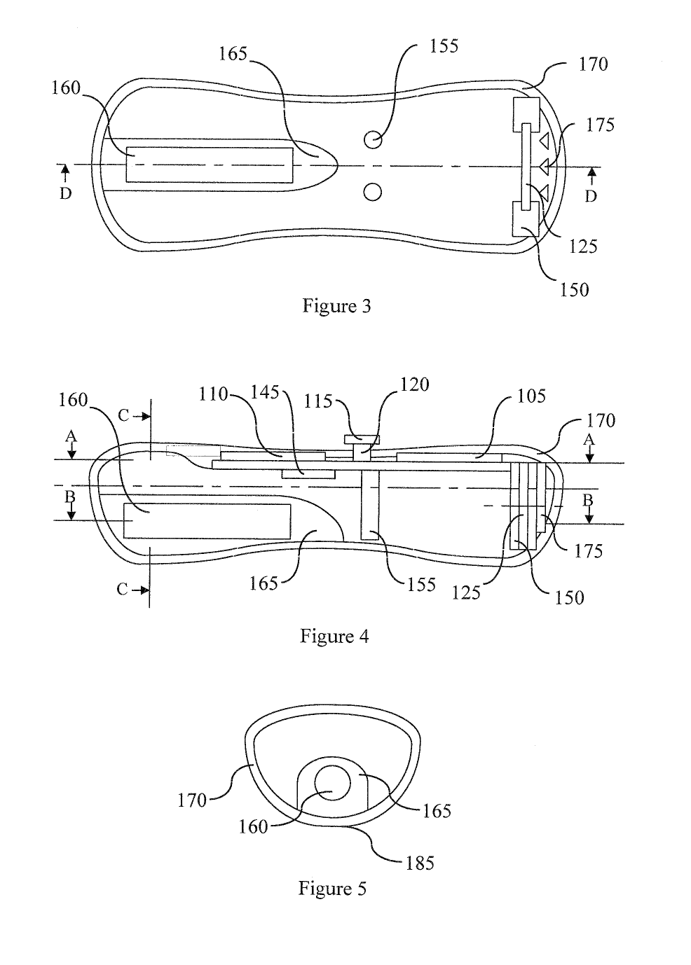

FIG. 3 represents, schematically, in a second horizontal longitudinal profile view, the device shown in FIG. 1;

FIG. 4 represents, schematically, in a vertical longitudinal cross-section view, the device shown in FIG. 1;

FIG. 5 represents, schematically, in a vertical lateral profile view, the device shown in FIG. 1;

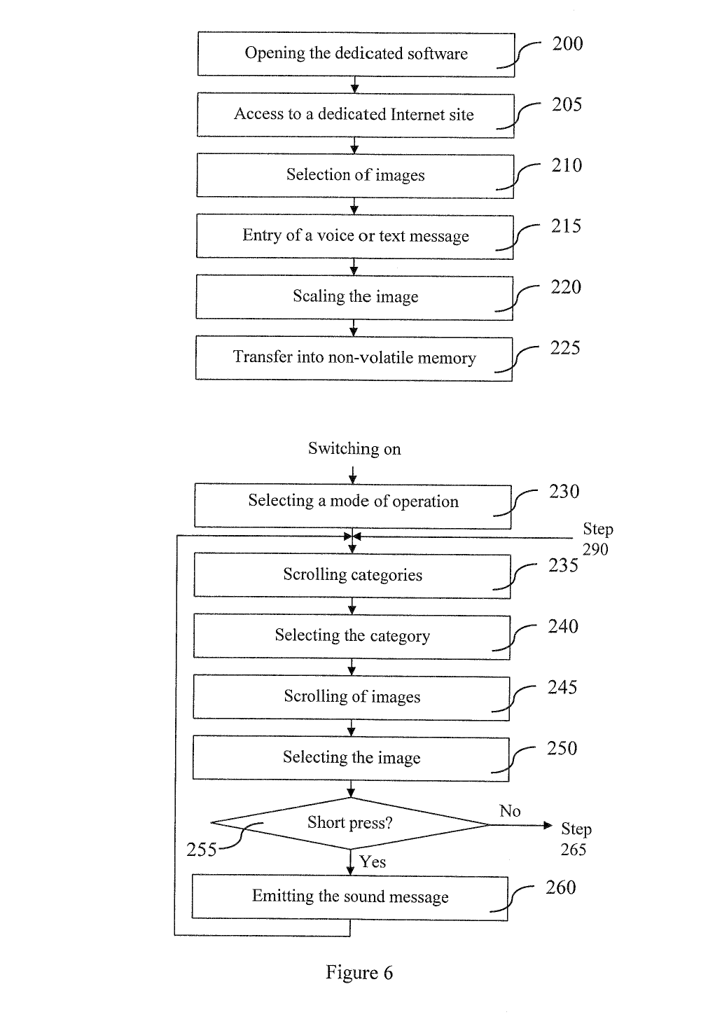

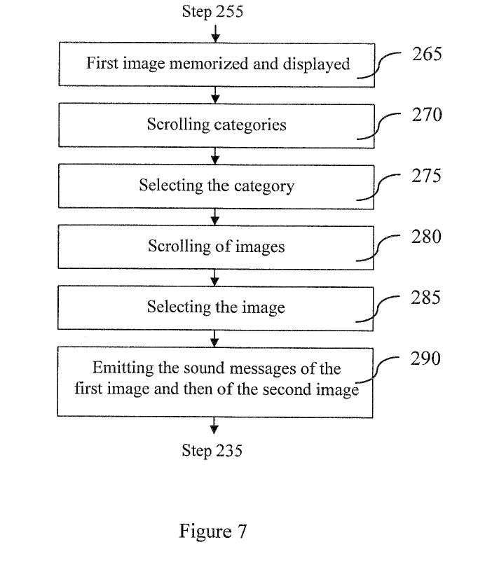

FIGS. 6 and 7 represent, in the form of logical diagrams, steps utilized in a particular mode of operation of the device that is the subject of the present invention and

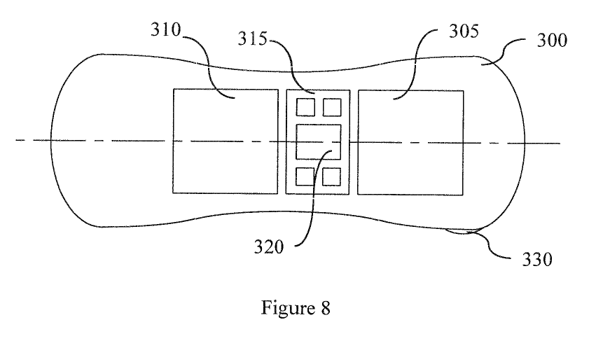

FIG. 8 represents, schematically, in a top view, a second particular embodiment of the device that is the subject of this invention.

The device that is the subject of the present invention is a communication aid tool for certain (permanently or temporarily) handicapped people. In these embodiments shown in FIGS. 1 to 5 and 8, it takes the general longilineal shape of a remote control in order to be held in the user's hand and so that it can be used with a single hand. This device is portable, easy to use with a single hand, simple, light, robust, hermetic, of great autonomy and it can be personalized.

It is noted that the figures are not to scale, as the device can, for example, have external dimensions of 14×6×3.5 centimeters and weigh approximately 150 grams. In the figures, the connecting wires for the various components and circuits are not shown.

FIG. 1 shows a housing 100 bearing on its upper surface two color screens 105 and 110 and a navigation bar 115 mechanically associated to a multidirectional switch 120, i.e. able to activate switches in multiple directions and, here, two directions in each horizontal direction and one direction in the vertical direction. This type of multidirectional switch is known under the name “joystick” (registered trademark).

The distance between the two screens 105 and 110 makes it possible to switch from one to the other with only a small movement of the finger and it is not necessary to change the position of the hand to make a selection on one or other of the screens.

These elements are found in FIG. 4, which is a vertical longitudinal cross-section view oriented according to the “D” arrows represented in FIGS. 1 and 3.

The “A” arrows represented in FIG. 4 correspond to the plane of the horizontal longitudinal cross-section of the profile shown in FIG. 2. FIG. 2 shows that the device comprises a shell 170 and a printed circuit 180 bearing the screens 105 and 110, the switch 120, a microcontroller 190, an ambient noise sensor 195 and a computer connector 145 and an analog connector 140. A dielectric (not shown) protects each screen and enables the capacitive detection to be optimized.

In embodiments, the shell 170 has, over at least one part of its surface, a non-slip coating.

The microcontroller 190 constitutes a means controlling each component of the device. It comprises, in particular, a non-volatile memory that holds:
an operating software system for the device, which implements, in particular, the steps represented in FIGS. 6 and 7,
images organized into categories, themselves associated to images representing them and sound messages associated to the various images.

Under screens 105 and 110 there are, on circuit 180, two copper loops 130 and 135, which follow the perimeter of the screens and are linked to two capacitive detectors (not shown). For preference, these capacitive loops 130 and 135 are surrounded, on circuit 180, by a ground plane and are superposed on a ground plane located on the other side of the circuit 180. The effect of these ground planes is to reduce the range of each capacitive loop, i.e. the distance at which it reacts to the presence of a finger.

Thanks to the capacitive sensors comprising the loops 130 and 135, the screens 105 and 110 are made tactile, i.e. the microcontroller 190 can receive from these sensors a signal indicating that the user has placed his/her finger on one of the screens 105 or 110.

For preference, screens 105 and 110 are not equipped with ground planes. The screens are, for preference, OLED-type (acronym for “organic light-emitting diodes”).

Around screens 105 and 110 there are finger-guides, which are deliberately accentuated flanges to lead the finger towards the corresponding touch-screen. The screens being, for preference, square, the microcontroller 190 can rotate the images 90, 180 or 270 degrees by means of the configuration menu described later. This function is used when the device is placed on a table or a base, in particular when it is used in combination with contactors, as described later, with the description of the connector 140.

The connector 145 complies, for example, with the USB (acronym for “universal serial bus”) standard and allows the device to be connected to a computer in order for it to memorize images and the associated messages, as explained with respect to FIG. 6, steps 200 to 225.

The connector 140 is, for example, a 3.5 mm-diameter four-pole audio-visual “Jack” (registered trademark) type of female connector. This connector has several functions: it allows earphones, for example used by the user or a particular speaker, or an additional audio input from a sound signal amplifier to be connected. This connector also enables two contactor-type accessories (not shown), which are sorts of large switches, also known as “bumpers”, used in the medical sector for significant motor handicaps, to be connected to the device. In fact, each of these contactors uses a shared ground and one of the inputs. These contactors make it possible to use the device when it is on a base (not shown) to scroll through or validate the images on the screens. In addition, the three poles that are additional to the ground pole make it possible to produce a parallel bus supporting three binary inputs, i.e. eight different signal values or a serial bus.

In variants, each of the connectors described above is replaced by a wireless connection, for example via Bluetooth or Wifi (registered trademarks).

The multidirectional switch 115 enables navigation between images displayed on screens 105 and/or 110. Vertical movements (i.e. longitudinal, with reference to the longitudinal axis of the remote control) allow images to be scrolled in the same direction of motion as that in which the switch 115 is pressed. A short press forwards or back scrolls a single image. A long press forwards or back scrolls images continuously until the pressure is released.

Lateral movements of the switch 115 allow the sound power emitted to be increased or reduced.

As described below, a short press on switch 115 makes it possible to go up a level in a tree structure of images to be displayed. A long press on switch 115 makes it possible to enter the device's configuration or parameter-setting mode of operation, allowing the following to be set, for example:
the mode of operation,
the brightness of the screens,
the duration of the presses,
the light intensity of the screens,
the rotation of images,
the language used,
the presence of a sub-title,
the device to be switched off and
in its version in which the housing is translucent and equipped with internal light-emitting diodes whose color depends on the voltage applied to them, the color of the device.

The ambient noise sensor 195, for example a microphone, also controls the sound power emitted so that, in an adaptive way, the sound message is audible and intelligible but is unlikely to be a nuisance to the surrounding area due to a sound volume that is too high with respect to the ambient sound. Thus, the switch 115 only controls the difference, in decibels, between the ambient noise and the sound volume emitted.

As can be seen in FIG. 3, which is the profile represented by the “B” arrows in FIG. 4, the device comprises a loudspeaker 125 at the end of a resonance box delimited by the shell 170. In this resonance box the components such as the battery 160 are equipped with a fairing 165 and the strengthening elements 155 have a shape without a plane surface perpendicular to the longitudinal axis of the device, which is parallel to the axis of movement of the loudspeaker 125.

The device's acoustics are thus designed to offer a high tone reproduction. To this end, the loudspeaker 125 is positioned perpendicularly to the device's main axis and held in a clamp or groove 150. It thus isolates the resonance box's interior from the exterior. In addition, there are no sharp edges on the resonance box, but on the contrary rounded edges, possibly by means of fillets to eliminate any perpendicularity of a plane surface to the longitudinal axis of the device. The sound wave can therefore be amplified in the resonance box. In addition, in front of the loudspeaker 125, there are bars 175 with a triangular shape in cross-section, which guide the sound waves emitted by the loudspeaker 125 towards the vents, or openings (not shown) in order to optimize the loudspeaker's rendition. Each element, for example the battery 160, which is in the interior of the shell 170 of the device, and thus of the resonance box, is faired by plastic pieces to, again, mask the part of the component perpendicular to the device's longitudinal axis.

The upper flat shape and lower round shape of the device thus enable a better internal resonance and increase the sound power dissipated.

It is noted that the power gain being in the mid-ranges (the resonance box's resonance frequency being centered on, approximately, 1500 Hertz), the synthesized speech is more intelligible.

As can be seen in FIG. 4, in vertical longitudinal cross-section, the lower part of the device has a “W” shape with two bearing points separated by a concave arc allowing the device to be easily gripped.

As can be seen in FIG. 5, which is a lateral profile view identified, in FIG. 4, by the “C” arrows, the outside shape of the device is, with respect to its lower part, generally round and has a flat spot 185 in the vicinity of the device's bearing point when it is in a stable position and, for preference over the whole length of the device, in its horizontal plane of symmetry.

Because the battery 160 is positioned near to this bearing point, the center of gravity is below the center of curvature of the device's round shape.

The lower part of the device, the part that is in the hollow of the hand, thus has a round shape, over a cross-section of the device perpendicular to its longitudinal axis. This gives a “weeble” effect to the device: when the device is placed on the side, the position of its center of gravity, near the lower part, the round shape and the flat spot causes it to stabilize quickly in a configuration where the upper surface, which bears the screens, is horizontal. In addition, the flat spot makes it possible to position the user's fingers when he/she has the device in their hand.

It is noted that a wrist-strap, not shown, makes it possible to attach the device to the user's wrist in order to avoid the device falling and in order to free, for short periods, the hand of the user operating the device.

In embodiments, the device comprises, in addition, a capacitive sensor placed in its lower part and adapted to detect the device being handled. This capacitive sensor allows the device to exit stand-by mode when the user picks it up.

Thanks to the technical provisions described above, the inventers have noted two days autonomy in continuous use, the recharging of the battery 160 being carried out via the connector 145.

Now the way in which the device is personalized by its user and how it operates is going to be described, with reference to FIGS. 6 and 7.

During a step 200, the user starts up a dedicated software system. During an optional step 205, the user accesses a dedicated Internet site, according to techniques known per se. This site comprises, in particular, a library of images and icons.

During a step 210, the user makes a selection of images, either on the dedicated site, or on another site, or on his/her computer or a camera, for example. The user arranges these images into categories of images. These categories are, for example, “actions”, “hospital”, “fruits”, “vegetables”, “meat”, “fish”, etc.

During a step 215, the user enters a text that he/she wishes to associate to each image selected. To do this, he/she can use the computer's keyboard, a microphone built into the computer or a piece of text associated, on the dedicated site, to the image in question.

Possibly, during the step 215, the dedicated Internet site automatically provides a translation of the text entered, in a language chosen by the user.

During a step 220, the computer carries out a scaling operation for each image, i.e. it replaces it by an image having a definition equal to or less than that of screens 105 and 110. During this same step, if the speech synthesis is not performed by the microcontroller 190, the computer or the site server performs the speech synthesis for the text entered and associates the sound signals produced to the corresponding image, in the computer memory. It is noted that, for this speech synthesis, the user can choose a man's, woman's or child's voice and a language.

For preference, during the step 220, the computer supplies the device with the message associated to each image with a view to its sub-titling.

During a step 225, the images selected and arranged into categories and the associated text or sound signals are downloaded into the non-volatile memory of the device 100, for example by means of the connector 145.

In this way, the whole tree structure, i.e. all the categories and all the images in the various categories, can be personalized thanks to the computer. With his/her computer, the user chooses images to which he/she associates phrases keyed in via the computer keyboard or sounds recorded with the help of a microphone. The user can also, on the Internet, choose images and/or associated messages. The images are automatically formatted for the device's screens by the computer software system.

When, later, the user switches the device 100 on or makes it exit from “standby” mode by means of the multidirectional switch 120 or a capacitive sensor, at the end of its initialization, during a step 230, the user chooses a mode of operation.

In a first mode of operation, the user can navigate the tree structure of categories and images for the category chosen. The screens are used to display two successive images in a list of images corresponding to a category. During the scrolling operation, each image is displayed successively on the two screens. Thus, if the images “apple” and “pear” are displayed on the front screen 105 and rear screen 110 respectively, after a forwards press on the joystick 115, the image “pear” appears on the front screen 105.

In a second navigation mode, the images representing the categories are scrolled on the front screen 105 and the images for the category selected with the front screen 105 are scrolled on the rear screen 110. A press on one of the screens makes it possible to confirm the category (e.g. “fruits”) or the image in the category (e.g. “apple”).

During a step 235, the user scrolls the images that represent categories by utilizing the joystick 115. A short press only scrolls a single image. A long press scrolls the images continuously, at a speed that allows them to be recognized.

If the operational parameter-setting indicates subtitles for the images, the device incrusts within each image the message associated to the image. If the message cannot be displayed in full on one line and remain legible, the device scrolls it sideways underneath the image.

The multidirectional switch thus allows navigation between the images of the categories. Vertical movements (i.e. longitudinal, with reference to the longitudinal axis of the remote control) allow images to be scrolled, in the same direction as the direction in which the switch 115 is pressed. A short press forwards or back scrolls a single image. A long press forwards or back scrolls images continuously until the pressure is released.

It is noted that lateral movements of the switch 115 allow the sound power emitted to be increased or reduced.

During a step 240, the user selects a category. To do this, he/she just needs to touch the image of the category selected with a finger. Then the messages available in the category are displayed and can be scrolled on the screens, during a step 245, as described above.

It is noted that, to return to the category selection, it is just necessary to press on switch 115 with a short press. A long press on switch 115 make it possible to enter the device parameter-setting mode of operation, for example to adjust the brightness of the screens, the length of time for presses, etc.

It is also noted that, in the first mode of operation, using the two screens so that the images are displayed twice, i.e. successively on the two screens, during a scrolling operation, improves the speed with which images are recognized. Cognitive psychology, immediate memory and retinal persistence reasons are thus taken into account through the utilization of two screens. In addition, using two small screens rather than one large one presents advantages with respect to autonomy (two small screens consume less than one large screen), robustness (a breakdown is limited to a single screen and leaves one of them available) and the fight against the effects of certain illnesses that reduce the ability to dissociate images.

Then, during a step 250, the user selects an image in a category, by pressing his/her finger on the screen that represents this image.

During a step 255, it is determined whether the user's press on the screen is short, for example less than two seconds, or long.

If the length of the press is short, during a step 260 the microcontroller 190 actuates the emission, by the loudspeaker 125, of the sound signal associated to the image selected, possibly by synthesizing its speech from a stored text. Thus, if you press on the image of an apple, the device 100 says, “I would like to eat an apple”.

Then you return to step 235.

If the length of the press is long, during a step 265 (FIG. 7), the microcontroller 190 memorizes the text associated to the image selected which, in the rest of the description, will be called “first” and displays the first image selected on one of the screens, until the end of the step 290.

Then, during steps 270 to 285, steps 235 to 250 respectively are reproduced. At the end of step 285, i.e. when a second image has been selected, during a step 290 the microcontroller 190 causes the sound signals associated to the first image selected, and then to the second image selected, to be emitted consecutively. Then you return to step 235.

The device's standby mode, not shown, is activated when no user interaction has been detected for a predefined length of time, for example two minutes.

Thus, in each of the navigation modes, the length of presses is used to activate different actions. With a short press, the message associated to the first image is output. With a long press, this message is kept in memory and displayed continuously on the front screen 105, until a second image is selected via the rear screen, by selecting a category and then a message in the selected category. The message corresponding to the front image, the first image selected, is then uttered first of all, followed by the message corresponding to the rear image, the second image selected. For example, first of all, in the category “action”, the message “I want” is selected, and then, in the category “fruit”, the message “an apple” is selected.

In the second embodiment, illustrated in FIG. 8, a housing 300 bears, on its upper surface, two color screens 305 and 310 and a navigation keyboard 315 comprising a central validation key 320. It also comprises, on a side surface, a thumbwheel switch/modulator 330 that makes it possible to put the device on standby or to wake it up and it used to adjust the volume.

The color screens 305 and 310 comprise, on their upper surface, resistive pads that, with respect to the first embodiment, replace the capacitive sensors placed under the screens. The pressing of a finger or object can thus be detected thanks to the variations of the electrical resistance. The metallization of the resistive pad's layers also allows capacitive technology to be used. The combination of the two technologies enables the device's service life to be increased.

In the navigation keyboard 315, with respect to the first embodiment, the central joystick is replaced by five capacitive keys. The ergonomics are thus improved for certain users and this replacement makes it possible for the shell to have improved hermeticity. With the keyboard 315, pressing simultaneously on the central key 320 and on the two screens 305 and 310 makes it possible to deactivate the device's power supply. The assignment of the keys can be configured, as described above. For example, the two side keys closest to the screen 305 bear arrow symbols and pressing on these keys causes the scrolling of images displayed on the screens and the side keys closest to screen 310 bear other symbols and pressing on these keys represent agreement or disagreement. The central key 320 can thus allow the user to return to his/her personal menu. For preference, the keyboard keys 315 are backlit with different colors of light-emitting diodes, the choice of the colors used being left to the user during configuration.

With regard to the operation of each four-wire resistive touchpad, this has a structure with two superposed elements:
a glass substrate bearing a uniform resistive layer in ITO (indium tin oxide) and
a polyester film superposed on the substrate and bearing, on the substrate side, an ITO resistive layer and, on the opposite surface, a hard and durable coating.

The substrate and the film are separated by small transparent printed insulation spacer dots.

When the polyester film is touched by the user, it moves towards the substrate until an electrical contact is formed between the two ITO layers. The resistance formed between the two conductive layers thus has a minimum value detected by an electrical circuit of a known type. It is noted that the position of the press can also be determined with this resistive pad.

For preference, in order to increase the device's service life, a capacitive sensor utilizing the same elements as the resistive pad described above has been added. The resistive pad being metallized, one of its terminals is connected to a detection terminal of the QT1103 (Manufacturer QUANTUM, registered trademark) integrated circuit. The capacitive sensor is based on the generation of an alternating current that passes, by capacitive effect, through the user and the “ground”. The principle is to measure the current that is established between the electrode (direct electrical link), the user (capacitive link), the ground (capacitive link) and the return feed to the circuit (capacitive link or direct connection to the ground).

1- An assistive device that comprises, in a portable housing adapted for use with a single hand:
at least two screens adapted to display images representative of messages,
a selector for selecting at least one message displayed on one of said screens,
an emitter for emitting sound messages and
a control means for controlling the emission, by said emitter, of sound signals representative of each message selected with said selector.

2- The device of claim 1, wherein at least one of said screens is a touch-screen that comprises both a capacitive sensor and a resistive sensor.

3- The device of claim 1, wherein at least one of said screens is a touch-screen that comprises a capacitive sensor comprising a conductive loop positioned under said screen.

4- The device of claim 3, wherein said loop is surrounded and/or superposed on a ground plane.

5- The device of claim 1, wherein the selector and the control means are adapted to control the scrolling of images on at least one of the screens so that, during a scrolling operation, the same image is displayed successively on at least two screens.

6- The device of claim 1, wherein the selector is placed between two of said screens.

7- The device of claim 1, wherein the selector and the control means are adapted to, firstly, scroll message categories and then, following the selection of a message category, to scroll messages for the category selected.

8- The device of claim 1, wherein the selector and the control means are adapted to scroll message categories on one of said screens and, following the selection of a message category, to scroll messages for the category selected on the other one of said screens.

9- The device of claim 1, wherein the selector is adapted to select, to begin with, a first message, the first message being memorized by the control means, then a second message, the control means being adapted to actuate the emission of the first and second message consecutively, by the emitter.

10- The device of claim 1, that comprises an internal resonance box, one wall of which is formed by the emitter.

11- The device of claim 10, wherein said resonance box comprises component fairings adapted to avoid, except at its end opposite to the emitter, the surfaces perpendicular to one axis of movement of the emitter.

12- The device of claim 1, that has, in lateral cross-section passing through its bearing points in a stable position, a round shape and a center of gravity positioned below the centre of curvature of said round shape.

13- The device of claim 1, that comprises a connector adapted to connect it to a computer, the control means being adapted to receive and memorize images associated to messages by means of said connector.
